(19) United States
(12) Patent Application Publication
(10) Pub. No.: US 2010/0104098 A1
(43) Pub. Date: Apr. 29, 2010

(54) CRYPTOGRAPHIC METHOD AND DEVICE FOR SCHEDULING AND COMPRESSING MESSAGE BASED ON SECURE HASH ALGORITHM

(75) Inventors: Moo-Seop KIM, Daejeon (KR); Young-Soo PARK, Daejeon (KR); Ji-Man PARK, Daejeon (KR); Young-Sae KIM, Daejeon (KR); Hong-Il JU, Daejeon (KR); Sung-Ik JUN, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/483,369

(22) Filed: Jun. 12, 2009

(30) Foreign Application Priority Data
Oct. 29, 2008 (KR) 10-2008-0106552

(51) Int. Cl. H04K 1/00; H04L 9/28

(52) U.S. Cl. 380/269; 380/28; 380/255

(57) ABSTRACT

The present invention relates to a secure hash algorithm (SHA)-based message schedule operation method, a message compression operation method, and a cryptographic device performing the same. The present invention sequentially performs the message schedule operation by using an adder. Also, a memory for storing operation data input for the message schedule operation is used from a 17th round to store intermediate data generated by the message schedule operation. Further, the message compression operation is sequentially performed by using one adder.

### CROSS-REFERENCE TO RELATED APPLICATION

This application claims priority to and the benefit of Korean Patent Application No. 10-2008-0106552 filed in the Korean Intellectual Property Office on Oct. 29, 2008, the entire contents of which are incorporated herein by reference.

### BACKGROUND OF THE INVENTION

(a) Field of the Invention

The present invention relates to a message scheduling operation method, a message compressing operation method, and an encrypting device for performing the same. Particularly, the present invention relates to a secure hash algorithm-based message scheduling operation method, a message compressing operation method, and an encrypting device for performing the same.

(b) Description of the Related Art

Recently, as wireless network skills have been rapidly developed, the digital information society has been developed, and electronic commerce has been activated, encryption skills has become recognized as a core skill for security and reliability of social and economical activities, and user privacy protection based on the fast Internet. Particularly, a mobile platform such as a mobile phone can be attacked by a hacker or another malicious program if it has no appropriate security measures.

The mobile phone working group (MPWG) of the trusted computing group (TCG) extends the security standards of the TCG so as to fit the mobile phone device. The mobile trusted module (MTM), which is a requisite security module for the mobile phone in the security standards, is designated to use the secure hash algorithm-1 (SHA-1) hash function using no key in order to measure integrity of the corresponding platform. However, usage of a secure hash algorithm-256 (SHA-256) is recommended and specified in order to stably use the hash function. By applying the change of encryption paradigm, the TCG has specified the usage of SHA-256 in the TPM NEXT, which is the standard of the next version of the TPM in the current progress.

Since most mobile devices have limits regarding memory, power, and computing performance, it is difficult to apply the security standards of TCG to the mobile phone. Particularly, as the mobile phone has a limit of battery capacity, it is greatly influenced by power consumption. Therefore, a design skill for the SHA-256 cryptographic circuit with small area and less power consumption is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a secure hash algorithm-based (SHA-based) message scheduling operation method with a small area and less power consumption, a message compression operation method, and a cryptographic device for performing the same.

An exemplary embodiment of the present invention provides an SHA-based cryptographic device including: a message scheduler, including an adder, for outputting part of data from among input operation data as per-round intermediate data before a first round, and using the adder to add a resultant value generated by performing a first operation function of the SHA on first intermediate data, and a resultant value generated by performing a second operation function of the SHA on second intermediate data, third intermediate data, and fourth intermediate data according to a predetermined order over a plurality of stages to output an added value as intermediate data for each round from the first round; and a message compressor for generating final resultant data of a hash operation by performing a message compression operation on the intermediate data output by the message scheduler for each round.

Another embodiment of the present invention provides an SHA-based cryptographic device including: a message scheduler for generating and outputting per-round intermediate data by using input operation data; and a compressor including an adder and a plurality of registers, and loading a plurality of initial values onto the plurality of registers when a hash operation starts, adding values stored in the registers, resultant values acquired by performing operation functions of a hash operation by using the values stored in the registers, the intermediate data, and the round constant through the adder according to a predetermined order through a plurality of stages for each round of a message compression operation when the initial values are loaded, updating the values stored in the registers by using the value added through the adder, and generating final resultant data by adding the plurality of initial values and the values stored in the registers when the message compression operation performed over the plurality of rounds is finished.

Yet another embodiment of the present invention provides a message schedule operation method of an SHA-based cryptographic device, including: when receiving operation data, dividing the operation data into a plurality of blocks to store them into a memory having the same size as the operation data; before a first round, sequentially outputting a plurality of blocks stored in the memory as per-round intermediate data of the first round; and from the first round, adding a resultant value acquired by performing a first operation function of the SHA on the first intermediate data output in the previous first round, a resultant value acquired by performing a second operation function of the SHA on the second intermediate data output in the previous second round, and third intermediate data and fourth intermediate data output in the previous third round and fourth round according to a predetermined order through a plurality of stages by using an adder for each round, and outputting per-round intermediate data from the first round.

According to an embodiment of the present invention, a method for performing a message compression operation including a first operation function, a second operation function, a third operation function, and a fourth operation function by using per-round intermediate data generated through a message schedule operation of an SHA-based cryptographic device includes: loading a plurality of initial values to a plurality of registers including a first register, a second register, and a third register; adding a value stored in the first register, resultant values acquired by respectively performing the first operation function, the second operation function, the third operation function, and the fourth operation function by using part of the plurality of registers, intermediate data of the corresponding round, and a round constant according to a predetermined order through a plurality of stages by using an adder, and selectively storing the added resultant values in one of the first register, the second register, and the third register; shifting values stored in the registers other than the third register from among the plurality of registers to neighboring registers by one step and storing them; repeating the selectively storing and the shifting, and storing over a plurality of rounds; and adding the values stored in the plurality of registers and the plurality of initial values, and outputting final resultant data of the hash operation.

According to the present invention, an SHA-based cryptographic device with a small-area and low power consumption structure is provided.

### BRIEF DESCRIPTION OF THE DRAWINGS

FIG. 1 shows a configuration diagram of an SHA-256 cryptographic device according to an exemplary embodiment of the present invention.

FIG. 2 shows a detailed view of a message scheduler according to an exemplary embodiment of the present invention.

FIG. 3 shows a detailed view of a message compressor according to an exemplary embodiment of the present invention.

FIG. 4 shows a flowchart of a message scheduling operation method by an SHA-256 cryptographic device according to an exemplary embodiment of the present invention.

FIG. 5 shows a flowchart of a message compression operation method by an SHA-256 cryptographic device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

A secure hash algorithm (SHA)-based cryptographic method and cryptographic device according to an exemplary embodiment of the present invention will now be described in detail with reference to accompanying drawings. Particularly, an SHA-256-based cryptographic method and cryptographic device will be exemplified in the exemplary embodiment of the present invention.

The SHA-256 as the hash algorithm will now be described in detail.

First, the SHA-256 represents a hash operation for receiving a message with a maximum length of 2⁶⁴ bits and outputting a 256-bit compressed message (i.e., a message digest). In the SHA-256, operations are performed per unit of 512 bits in order to perform one hash operation, and the operations are internally performed over 64 rounds in order to perform a hash operation for one 512-bit operation datum. The SHA-256 uses the subsequent six 32-bit operation functions of Equation 1 in order to calculate the message digest.

Ch(x,y,z)=(x [symbol] y)⊕( x̅ [symbol] z)

Maj(x,y,z)=(x [symbol] y)⊕( x̅ [symbol] z)⊕(y [symbol] z)

Σ₀(x)=S²(x)⊕S¹³(x)⊕S²²(x)

Σ₁(x)=S⁶(x)⊕S¹¹(x)⊕S²⁵(x)

σ₀(x)=S⁷(x)⊕S¹⁸(x)⊕R³(x)

σ₁(x)=S¹⁷(x)⊕S¹⁹(x)⊕R¹⁰(x) (Equation 1)

Here, ̂ and ⊕ respectively represent an AND operation and an XOR operation performed per bit, and S and R respectively indicate a rotate right operation and a shift right operation.

The SHA-256 is realized with a message scheduling operation and a message compression operation. The message scheduling operation generates 32-bit intermediate data needed for a message compression operation performed over 64 rounds from the 512-bit input operation data by using the functions σ₀( ) and σ₁( ) of Equation 1 as shown in Equation 2.

$${W}_{t} = \{ \begin{matrix}{M}_{t} & 1 \leq t \leq 16 \\ \begin{matrix}{σ}_{1} ( {M}_{t - 2} ) + {M}_{t - 7} + \\ {σ}_{0} ( {M}_{t - 15} ) + {M}_{t - 16}\end{matrix} & 17 \leq t \leq 64\end{matrix} \qquad ( Equation 2 )$$

Here, Mₜ represents 32-bit intermediate data of the t-th round used as an input of the message compression operation. Referring to Equation 2, during the message scheduling operation, 32-bit data generated by dividing 512-bit input operation data into 16 blocks are sequentially output as intermediate data until the initial 16th round, and new 32 bit intermediate data are calculated and output for each round by using the operation function (σ₀, σ₁) of Equation 1 in other rounds.

In order to perform the message schedule operation, the cryptographic device requires a 512-bit memory and 16 shift registers for storing 512-bit input operation data. The above-configured cryptographic device directly reads 32-bit data from a 512-bit memory for storing 512-bit operation data and outputs them as intermediate data during the message scheduling operation up to the initial 16th round, and it calculates new 32-bit intermediate data and uses them for each round during other rounds. Therefore, the 512-bit memory used for storing the 512-bit input operation data is used for the message scheduling operation up to the initial 16th round, and it is not used for the message scheduling operation during other rounds. Since the cryptographic device expends many resources from the viewpoint of the circuit area and power consumption, it is difficult to apply the cryptographic device to a mobile phone requiring low power consumption and small-area characteristics or any other low power consumption embedded systems.

Regarding the message compression operation, as shown in Equation 3, a message compression operation for the 32-bit intermediate data generated through a message scheduling operation is repeatedly performed over 64 rounds by using Σ₀( ), Σ₁( ), Ch( ), and Maj( ) functions of Equation 1.

T₁=h+Σ₁(e)+Ch(e,f,g)+Kₜ+Wₜ;

T₂=Σ₀(a)+Maj(a,b,c);

h=g; g=f; f=e; e=d+T₁;

d=c; c=b; b=a; a=T₁+T₂ (Equation 3)

Here, Wₜ represents 32-bit intermediate data output for each round through the message scheduling operation, and Kₜ indicates a 32-bit round constant defined by the SHA-256. Also, a, b, c, d, e, f, g, and h represent variables used for the message compression operation, and the variables are shifted by one stage for each round or store different values according to a predetermined operation.

Referring to Equation 3, 7-times 32-bit addition operations are needed for the message compression operation. Therefore, in the cryptographic device, an adder needs the largest circuit area for the message compression operation. Accordingly, when a plurality of adders are used for a plurality of addition operations, a high-speed message compression operation is allowable and the circuit area and power consumption of the cryptographic device are increased, and they cannot be used for the mobile phone or other low power consumption embedded systems.

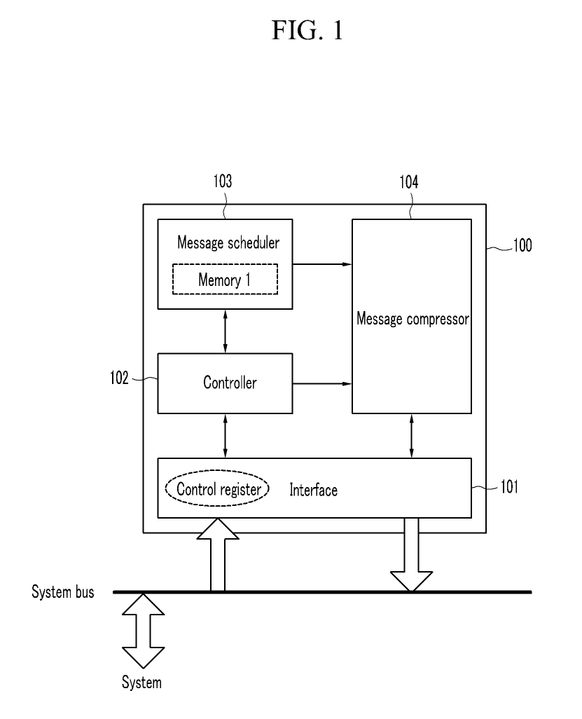

FIG. 1 shows a configuration diagram of an SHA-256-based cryptographic device 100 according to an exemplary embodiment of the present invention.

Referring to FIG. 1, the SHA-256-based cryptographic device 100 includes an interface 101, a controller 102, a message scheduler 103, and a message compressor 104.

The interface 101 is connected to a system bus of a system using the cryptographic device 100, and it receives operation data and control instructions input to the cryptographic device 100 from the system bus. Also, it transmits SHA-256 operation resultant data, an interrupter signal for notifying termination of the operation, and a polling signal to the system through the system bus.

Further, the interface 101 receives a control instruction from the system through the system bus, and stores it in a control register. The control instruction stored in the control register is referred to by the controller 102 and is then used to generate a control signal for driving the cryptographic device 100. Here, the respective bits of the control register use predefined values so as to control the operation of the cryptographic device 100.

Also, when receiving the operation data from the system through the system bus, the interface 102 stores the input operation data in a first memory in the message scheduler 103 based on the control signal of the controller 102. Here, the controller 102 applies a control signal for setting a storage path for storing operation data in a first memory of the message scheduler 103 to the interface 102.

The controller 102 controls overall data flows of the cryptographic device 100.

First, the controller 102 controls an operation performance order and an operation result storage process for driving inner modules of the message scheduler 103 and the message compressor 104 over 64 rounds in order to perform the SHA-256 operation.

Also, the controller 102 controls data input and output through the interface 101, and determines whether corresponding data are a control instruction or operation data based on an address of the data input to the interface 101. When the input data are a control instruction, the controller 102 controls the interface 101 to store the same in the control register, and analyzes the control instruction stored in the control register to determine the type of operation to be performed by the cryptographic device 100. It also controls a state transition of the cryptographic device 100 to perform the operation.

When the input data are operation data, the controller 102 controls the interface 101 in order to store them in the first memory of the message schedule 103. Here, the controller 102 controls the address in the first memory for storing the operation data input through a control signal and a storage order of the operation data.

The message scheduler 103 includes a first memory, and it stores operation data input through the interface 101 in the first memory and generates 32-bit intermediate data for performing a message compression operation over the entire 64 rounds and transmits them to the message compressor 104 by using the input operation data.

The message compressor 104 performs the message compression operation, that is, the SHA-256 hash operation, performs the 64-round operation for the 32-bit intermediate data input by the message scheduler 103, and stores final resultant data in the inner register.

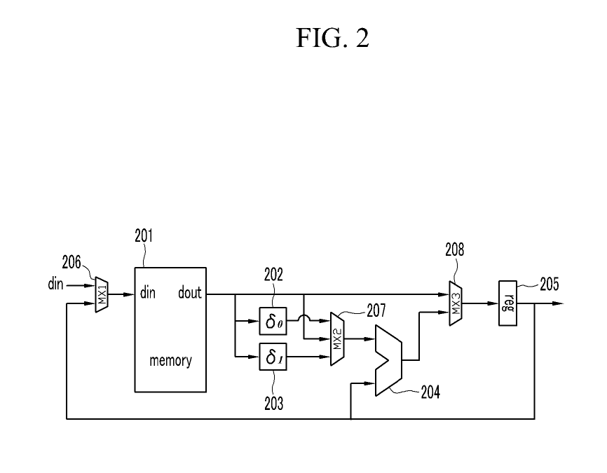

FIG. 2 shows a detailed view of the message scheduler 103 according to an exemplary embodiment of the present invention.

Referring to FIG. 2, the message scheduler 103 includes a first memory 201, a first operation function operator 202, a second operation function operator 203, a first adder 204, and a register 205. The message scheduler 103 may further include a first multiplexer 206, a second multiplexer 207, and a third multiplexer 208.

The first memory 201 has 512-bit capacity, divides the 512-bit operation data input to the message scheduler 103 into 16 blocks and stores them up to the 16th round, and sequentially stores the 32-bit intermediate data output by the message scheduler 103 other than the operation data from the 17th round. Here, the operation data become intermediate data since the sixteen 32-bit data included in the operation data are sequentially output as intermediate data up to the 16th round. Therefore, up to the 16th round, there is no need to update the operation data with the intermediate data that are output by the message scheduler 103.

The first operation function operator 202 performs the first operation function (σ₀) on the intermediate data output at the (t−15)-th round from among the intermediate data stored in the first memory 201 based on Equation 2 from the 17th round, and then outputs results. Here, t indicates which round the current round corresponds to.

The second operation function operator 203 performs the first operation function (σ₁) on the intermediate data output at the (t−2)-nd round from among the intermediate data stored in the first memory 201 based on Equation 3 from the 17th round, and then outputs results.

From the 17th round, the first adder 204 adds intermediate data output at the (t−16)-th round over a plurality of stages for each round, an output value that is output by the first operation function operator 202, intermediate data that are output at the (t−7)-th round, and an output value that is output by the second operation function operator 203 according to a predetermined order, and then outputs results. For this, the added value generated by the first adder 204 for a plurality of stages is stored in the register 205, and the added value stored in the register 205 is input to the first adder 204 to be used for addition in the next stage.

For example, in the first stage, the intermediate data output at the (t−16)-th round are input through the first adder 204, and the first adder 204 outputs the intermediate data output at the (t−16)-th round. The intermediate data at the (t−16)-th round output by the first adder 204 are stored in the register 205, and are then output to the first adder 204 in the next stage. Therefore, in the second stage, the output value output by the first operation function operator 202 and the intermediate data at the (t−16)-th round are added to be output. The added value is stored in the register 205 and is then output to the first adder 204 in the next stage. According to this method, the first adder 204 adds the intermediate data at the (t−7)-th round and the sum of the intermediate data at the (t−16)-th round and the output value of the first logic function operator 202 and outputs results in the third stage, and the first adder 204 finally outputs intermediate data of the corresponding round by adding the output value of the second operation function 203 and the sum of the intermediate data at the (t−16)-th round, the output value of the first logic function operator 202, and the intermediate data at the (t−7)-th round in the fourth stage.

The register 205 stores the intermediate data output by the first memory 201 and the added values per stage output by the first adder 204 for respective rounds. That is, the register 205 stores the intermediate data output per round by the first memory 201 up to the 16th round, and stores one of the intermediate data of the previous round output by the first memory 201 for the purpose of the message schedule operation and the added values output by the first adder 204 for respective stages after the 17th round. Here, the value stored in the register 205 in the last stage of each round is the intermediate data of the corresponding round.

The first multiplexer 206 selects one of the 512-bit operation data input to the message scheduler 103 and the intermediate data per round output by the register 205, and outputs the same to the first memory 201. That is, the first multiplexer 206 outputs the 512-bit input operation data to the first memory 201 up to the 16th round, reads the intermediate data finally generated for the respective rounds from the register 205, and outputs the same to the first memory 201 from the 17th round.

The second multiplexer 206 selects one of the intermediate data at the (t−16)-th round, output value of the first operation function operator 202, intermediate data at the (t−7)-th round, and output value of the second operation function operator 203 from among the values input for respective stages, and outputs the same after the 17th round.

The third multiplexer 206 selects one of the intermediate data output by the first memory 201 and the output value of the first adder 204, and outputs the same to the register 205. That is, the third multiplexer 206 outputs the 32-bit data sequentially output by the first memory 201 to the register 205 up to the 16th round, and outputs the output values of the first adder 204 output for the respective stages to the register 205 from the 17th round.

Table 1 shows performance results for the respective rounds based on operations of respective constituent elements of the message scheduler 103. In Table 1, x represents a “don't care” value.

TABLE 1
Operations of the message scheduler for rounds

| | Operation of circuit blocks | | | | | |
|---|---|---|---|---|---|---|
| | | Output of | Output of | Output of | Output | Output of |
| Round(i) | Step | memory 1 | mux 2 | adder 1 | of mux 3 | register |
| 1-16 | 1 | Mᵢ | x | x | Mᵢ | → |
| 17 | \textcircled{1} | M₁ | x | x | M₁ | → |
| | \textcircled{2} | M₂ | σ₀(M₂) | M1 + σ₀(M₂) | → | → |
| | \textcircled{3} | M₁₀ | M₁₀ | M1 + σ₀(M₂) + M₁₀ | → | → |
| | \textcircled{4} | M₁₅ | σ₁(M₁₅) | M1 + σ₀(M₂) + M₁₀ + | → | → |
| | | | | σ₁(M₁₅) | | |

| | |
|---|---|
| 18-64 | Repeat above 17th round operation stages |

In order to perform the message scheduling operation, the first memory 201 of the message scheduler 103 stores data in the first memory 201 or outputs the data stored in the first memory 201 based on the control signal of the controller 102. Also, the first multiplexer 206, the second multiplexer 207, and the third multiplexer 204 select one of the input data based on the control signal of the controller 102, and output the same.

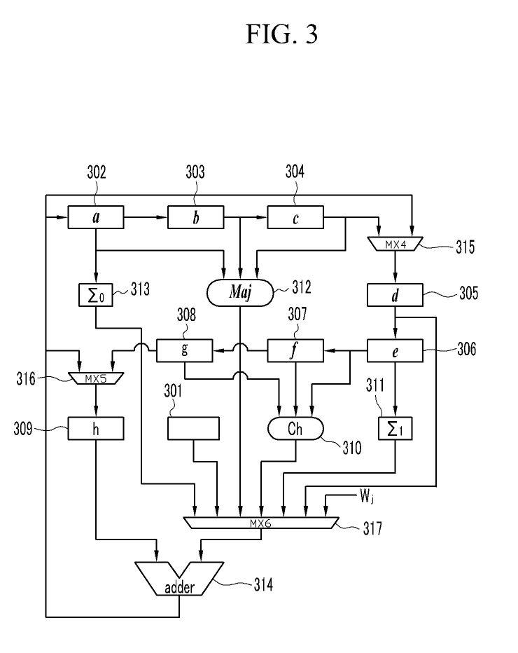

FIG. 3 shows a configuration diagram of a message compressor 104 according to an exemplary embodiment of the present invention.

Referring to FIG. 3, the message compressor 104 includes a second memory 301, 8 registers a, b, c, d, e, f, g, and h (302-309), a third operation function operator 310, a fourth operation function operator 311, a fifth operation function operator 312, a sixth operation function operator 313, a second adder 314, a fourth multiplexer 315, a fifth multiplexer 316, and a sixth multiplexer 317. The second memory 104 stores initial values H₀ to H₇ and a round constant Kₜ used for a message compression operation. Here, the round constant Kⱼ is stored in the lookup table format.

The plurality of registers 302 to 309 include shift registers, and store variables used for the message compression operation. First, when an SHA-256 hash operation is started, the initial values H₀ to H₇ are stored in the registers 302 to 309. Further, intermediate values generated during the message compression operation are stored per round, and when the message compression operation over the 64 rounds is finished, the final resultant data caused by the message compression operation are stored.

The third operation function operator 310 performs a third operation function Ch(,) on the register 305, register 306, and register 307 (e, f, and g), and outputs results.

The fourth operation function operator 311 performs a fourth operation function (Σ₁( )) on the value stored in the register e 305 and outputs a result.

The fifth operation function operator 312 performs a fifth operation function Maj(,) on the values stored in the register 302, register 303, and register 304 (a to c), and outputs a result.

The sixth operation function operator 313 performs a sixth operation function (Σ₀( )) on the value stored in the register a 302 and outputs a result.

The second adder 314 outputs the initial value output by the second memory 301 to the register a 302 for each clock signal while loading the initial value so that the initial values may be shifted and stored in the corresponding registers. Also, the second adder 314 sequentially adds the initial value H₇ stored in the register 309, the output value Ch(e,f,g) of the third operation function operator 310, the round constant Kⱼ of the corresponding round, the output value (Σ₁(e)) of the fourth operation function operator 311, the intermediate data (Wⱼ) caused by the message scheduling operation of the corresponding round, the initial value H₄ stored in the register d 305, the output value Maj(a,b,j) of the fifth operation function operator 312, and the output value (Σ₀(a)) of the sixth operation function operator 313 over a plurality of stages for each round of the operation message compression, and then outputs an added result. In this instance, the value output by the second adder 314 is selectively stored in one of the register 309, register 305, and register 304 (h, d, and a). Also, when the message compression operation is performed over the 64 rounds, the initial value output by the second memory 301 and the value stored in the corresponding register are added, and the added value is output to the register a 302 to update the initial values stored in the registers.

The fourth multiplexer 315 selects one of the value output by the register c 304 and the output of the second adder 314, and outputs it to the register d 305. The fourth multiplexer 315 selects the data output by the register c 304 during the process of loading the initial value into the register or performing the message compression operation over the 64 rounds to store the acquired final result data in the registers. On the other hand, the fourth multiplexer 315 selects the value output by the second adder 314 and outputs it while performing the message compression operation through a plurality of stages for each round.

The fifth multiplexer 316 selects one of the value output by the register g 308 and the output of the second adder 314, and outputs it to the register h 305. While loading the initial value to each register or performing the message compression operation over the 64 rounds to acquire final resultant data and store the same in each register, the fifth multiplexer 316 selects and outputs the data output by the register g 304. On the contrary, while performing the message compression operation through a plurality of stages for each round, the fifth multiplexer 316 selects and outputs the value output by the second adder 314.

The sixth register 317 selects one of the output values output by the third operation function operator 310, the fourth operation function operator 311, the fifth operation function operator 312, and the sixth operation function operator 313 for respective stages of the message compression operation based on Equation 3, the initial value output by the second memory 301, and the round constant, and outputs it to the second adder 314.

Table 2 shows performance result for respective rounds based on the operations of respective constituent elements of the message compressor 104.

TABLE 2
Operations of the message compressor for respective rounds

| Steps | Operation per round | Intermediate values |
|---|---|---|
| Step 1 | h = h + Ch(e, f, g) | h = h + Ch(e, f, g) |
| Step 2 | h = h + Kⱼ | h = h + Ch(e, f, g) + Kⱼ |
| Step 3 | h = h + Σ₁(e) | h = Σ₁(e) + Ch(e, f, g) + h + Kⱼ |
| Step 4 | h = h + Wⱼ | h = Σ₁(e) + Ch(e, f, g) + h + Kⱼ + Wⱼ |
| Step 5 | d = d + h | h = Σ₁(e) + Ch(e, f, g) + h + Kⱼ + Wⱼ |
| | | d = d + Σ₁(e) + Ch(e, f, g) + h + Kⱼ + Wⱼ |
| Step 6 | h = h + Maj(a, b, c) | h = Maj(a, b, c) + Σ₁(e) + Ch(e, f, g) + |
| | | h + Kⱼ + Wⱼ |
| Step 7 | a = h + Σ₀(a) | a = Σ₀(a) + Maj(a, b, c) + Σ₁(e) + |
| | | Ch(e, f, g) + h +Kⱼ + Wⱼ |
| | b = a | b = a |
| | c = b | c = b |
| | d = c | d = c |
| | e = d | e = d + Σ₁(e) + Ch(e, f, g) + h + Kⱼ + Wⱼ |
| | f = e | f = e |
| | g = f | g = f |
| | h = g | h = g |

Referring to Table 2, the values that are sequentially added for the respective stages by the second adder 314 are stored in one of the register 309, register 305, and register 302 (h, d, and a) for the respective stages.

The controller 102 outputs a control signal for controlling the message compressor 104 according to the message compression operation of Equation 3. Accordingly, the second memory 302 outputs the initial value stored in the second memory 302 or the round constant based on the control signal of the controller 102, or updates the initial value. Further, the fourth multiplexer 315, the fifth multiplexer 316, and the sixth multiplexer 317 select one of the values input based on the control signal of the controller 102, and output the same.

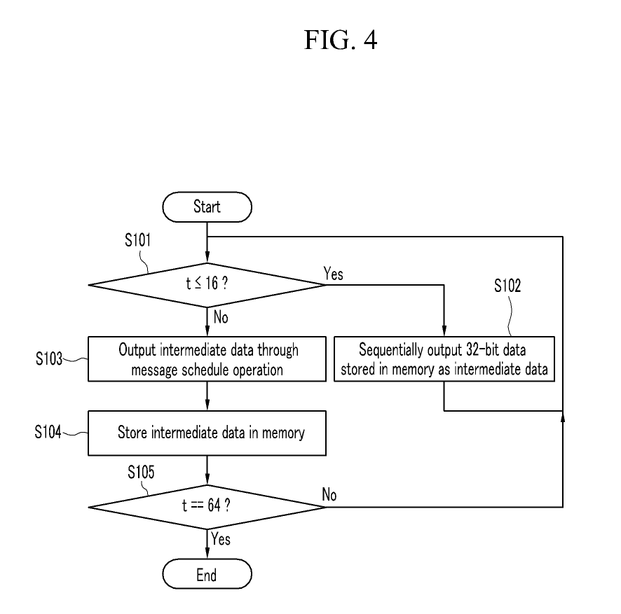

FIG. 4 shows a flowchart of a message schedule operation method by the message scheduler 103 according to an exemplary embodiment of the present invention.

Referring to FIG. 4, when 512-bit operation data are input to the message scheduler 103, the first multiplexer 206 controls to output the 512-bit operation data to the first memory 201, and the first memory 201 sequentially stores 32-bit data including sixteen 512-bit blocks.

The message scheduler 103 sequentially outputs the 32-bit data stored in the first memory 201 as per-round intermediate data until the initial 16th round (t≦16) (S101) and (S102). For this, the first memory 201 sequentially outputs the 32-bit data based on the control signal of the controller 102, and the second multiplexer 207 outputs the data output by the first memory 201 to the register 205. Therefore, the register 205 stores the data output by the second multiplexer 207, and the intermediate data stored in the register 205 are used as input data of the message compressor 104. Accordingly, since it is only needed to read the data from the first memory 201 in order to output the intermediate data up to the initial 16th round, 1 clock cycle is used for each round. The constituent elements other than the first memory 201, the register 205, and the second multiplexer 207 from among the constituent elements of the message operator 103 are operable irrespective of the input value up to the initial 16th round. That is, they do not influence determination of intermediate data.

From the 17th round to the 64th round, the message scheduler 103 performs the message schedule operation over a plurality of stages for each round to output intermediate data (S103), and repeatedly stores the generated intermediate data in the first memory 201 sequentially (S104) and (S105).

Here, the message schedule operation is performed four times, and the first adder 240 is used to add the resulting value σ₀(Mₜ₋₁₅) generated by performing the first operation function (σ₀) operation on the intermediate data Mₜ₋₁₆ output at the (t−16)-th round for respective stages and the intermediate data output at the (t−15)-th round, and the resulting value σ₁(Mₜ₋₂) generated by performing the second operation function (σ₁) operation on the intermediate data Mₜ₋₇ output at the (t−7)-th round and the intermediate data Mₜ₋₂ output at the (t−2)-th round. Since the message schedule operation uses 1 clock cycle for each stage, four clock cycles are expended as a total for the per-round message schedule operation.

In the first stage, the first memory 201 outputs the intermediate data Mₜ₋₁₆ output at the (t−16)-th round, and the third multiplexer 208 outputs them to the register 205. Therefore, in the first stage, the intermediate data output at the (t−16)-th round are stored in the register 205, and the value stored in the register 205 is input to the first adder 204 at the next stage. For example, at the 17th round, the intermediate data M₁ output at the first round are stored as a resulting value in the register 205 in the first stage, and the value is output as an input to the first adder 204 in the second stage.

In the second stage, the first memory 201 outputs the intermediate data output at the (t−15)-th round. Also, the first operation function operator 202 outputs the resulting value σ₀(Mₜ₋₁₅) generated by performing the first operation function (σ₀) on the intermediate data output at the (t−15)-th round, and the second multiplexer 207 outputs the same to the first adder 204. Accordingly, the first adder 204 adds the resulting value Mₜ₋₁₆ output in the previous stage and the output value σ₀(Mₜ₋₁₅) output by the first operation function operator 202, and outputs the result. Further, the value Mₜ₋₁₆+σ₀(Mₜ₋₁₅) output by the first adder 204 is stored in the register 205 through the third multiplexer 208, and the value stored in the register 205 is input as an input to the first adder 204. For example, in the case of the 17th round, the added value (M₁+σ₀(M₂)) of M₁ and σ₀(2) is stored in the register 205 in the second stage, and this value is output as an input of the first adder 204 in the third stage.

In the third stage, the first memory 201 outputs the intermediate data Mₜ₋₇ output at the (t−7)-th round, and the second multiplexer 208 outputs the same to the first adder 204. Accordingly, the first adder 204 adds the resulting value (Mₜ₋₁₆+σ₀(Mₜ₋₁₅)) output in the previous stage and the intermediate data Mₜ₋₇ output at the (t−7)-th round, and outputs the result. Also, the value (Mₜ₋₁₆σ₀ (Mₜ₋₁₅)+Mₜ₋₇) output by the first adder 204 is stored in the register 205 through the third multiplexer 208, and the value stored in the register 205 is input to the first adder 204. For example, at the 17th round, the value (M₁σ₀(M₂)+M₁₀) generated by adding (M₁+σ₀(M₂)) and M₁₀ is stored in the register 205 in the third stage, and the value is output as an input to the first adder 204 in the third stage.

In the fourth stage, the first memory 201 outputs the intermediate data Mₜ₋₂ output at the (t−2)-th round, and the second operation function operator 203 performs the second operation function (σ₁) operation on this value to output it. The value σ₁(Mₜ₋₂) output by the second operation function operator 203 is output to the first adder 204 by the second multiplexer 207, and the first adder 204 adds the value (σ₁(Mₜ₋₂)) output by the second operation function operator 203 and the value (Mₜ₋₁₆σ₀(Mₜ₋₁₅)+Mₜ₋₇) output in the previous stage, and outputs the result. Further, the value (Mₜ₋₁₆+σ₀(M_{t-15)+M}ₜ₋₇+σ₁(Mₜ₋₂)) output by the first adder 204 is stored in the register 205 through the third multiplexer 208, and the value stored in the register 205 is used as intermediate data for the corresponding round. That is, the value (Mₜ₋₁₆+σ₀(M_{t-15)+M}ₜ₋₇+σ₁(Mₜ₋₂)) stored in the register 204 in the fourth stage is used as intermediate data for the corresponding round by the message compressor 104, and it is stored in the first memory 201 for the message schedule operation at the next round. For example, in the case of the 17th round, the added value (M₁+σ₀(M₂)+M₁₀+σ₁(M₁₅)) of (M₁+σ₀(M₂)+M₁₀) and σ₁(M₁₅) is stored in the register 205 in the fourth stage, and this value becomes the final intermediate data at the 17th round.

The intermediate data generated from the 17th round from among the intermediate data generated for the respective rounds are sequentially stored in the first memory 201. Here, since the intermediate data output up to the 16th round sequentially correspond to the 16 blocks generated by dividing the 512-bit operation data input to the message scheduler 103 into 32-bit data, no additional storing process is needed. The intermediate data generated from the 17th round are overwritten on the address of the first memory 201 having stored the (i mod 16)-th block from among the 16 blocks generated by dividing the 512-bit data.

A control signal for the message scheduler 103 to read and write data from/to the first memory 201 and a control signal for selecting one of the data input by the multiplexers 206, 207, and 208 are output by the controller 102. Here, the control signal for controlling the first memory 201 includes an address of the first memory corresponding to a read/write selecting signal.

As described above, in the exemplary embodiment of the present invention, one 512-bit first memory, one first adder, and one register are used in order to realize the message scheduler 103. Therefore, utilization of the memory used for the message schedule operation is increased, and hardware area and power consumption are minimized.

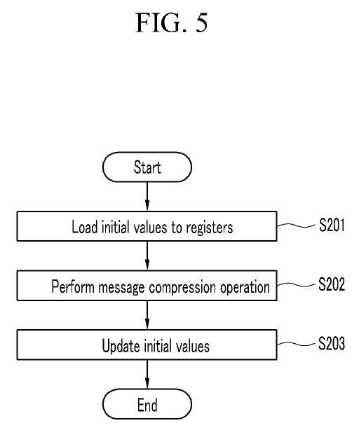

FIG. 5 shows a flowchart of a message compression operation method by the message compressor 104 according to an exemplary embodiment of the present invention.

Referring to FIG. 5, when the SHA-256 hash operation is started, the message compressor 104 sequentially loads the initial values (H₀-H₇) stored in the second memory 301 into a plurality of registers (a to h) (302 to 309) (S201). Here, 8 clock cycles are used so as to sequentially load the initial values into the registers (302 to 309), and each register is driven by a shift register to shift the value stored in the register to the neighboring register for each clock cycle, thereby performing a shift operation.

In detail, the second memory 301 sequentially outputs the initial values stored in the second memory 301 for each clock cycle based on the control signal of the controller 102. That is, the second memory 301 outputs H₇ from among the initial values at the first clock cycle, and sequentially outputs the initial values for each clock cycle in the order of H₆, H₅, . . . , H₀. The output initial values are output to the register a 302 through the sixth multiplexer 317 and the second adder 314. The values stored in the registers a to g are shifted by one stage to be stored in the registers b to h.

Therefore, H₇ is stored in the register a 302 in the first clock cycle, and 0's are stored in the other registers, and H₆ is stored in the register a 302 and H₇ is stored in the register b 303 in the second clock cycle. When the 8 clock cycles are finally passed, initial values are loaded into the respective registers such as a=H₀, b=H₁, c=H₂, . . . , h=H₇.

When the process for loading the initial values in the registers are finished as described, the message compressor 104 performs the message compression operation as shown in Equation 3 by using the 32-bit intermediate data input by the message scheduler 103 over the 64 rounds (S202). Here, the per-round message compression operation is performed over the total of 7 stages, and it uses the second adder 314 to sequentially add the initial value (a) stored in the register h 309, the output value (Ch(e,f,g)) of the third operation function operator 310, the round constant (Kⱼ), the output value σ₁(e) of the fourth operation function operator 311, the intermediate data (Wⱼ) caused by the message schedule operation of the corresponding round, the initial value (d) stored in the register d 305, the output value (Maj(a,b,c)) of the fifth operation function operator 312, and the output value Σ₀(a) of the sixth operation function operator 313. The added result is selectively stored in one of the register h 309, register d 305, and register a 304. Since 1 clock cycle is used for each stage of the message compression operation, 7 clock cycles are used in total for the per-round message compression operation.

In the first stage, the second adder 314 adds the initial value (h) stored in the register h 309 and the output value (Ch(e,f,g)) of the third operation function operator 310 to output an added result, and the added value (h+Ch(e,f,g)) is stored in the register h 309. For this, the sixth multiplexer 317 selects the output value (Ch(e,f,g)) of the third operation function operator 310 from among the input values to output it to the second adder 314, and the fifth multiplexer 316 outputs the value output by the second adder 314 from among the input values to the register h 309.

In the second stage, the second adder 314 adds the value (h+Ch(e,f,g)) stored in the register h 309 in the previous stage and the round constant (Kⱼ) to output an added result, and the added value (h+Ch(e,f,g)+Kⱼ) is stored in the register h 309. Here, the round constant (Kⱼ) corresponds to each round, and is stored in the second memory 301 in the lookup table format. Therefore, the second memory 301 output the round constant (Kⱼ) corresponding to the corresponding round based on the control signal of the controller 102, and the sixth multiplexer 317 selects the value (Kⱼ) output by the second memory 301 from among the input values, and outputs it to the second adder 314. Therefore, the second adder 314 adds the value (h+Ch(e,f,g)) stored in the register h 309 and the value (Kⱼ) output by the sixth multiplexer 317 and outputs a result value (h+Ch(e,f,g)+Kⱼ) which is stored in the register h 309 through the fifth multiplexer 316.

In the third stage, the second adder 314 adds the value (h+Ch(e,f,g)+) Kⱼ) stored in the register h 309 in the previous stage and the value (Σ₁(e)) output by the fourth operation function operator 311 to output a resultant value (Σ₁(e)+Ch(e,f,g)+h+Kⱼ) which is stored in the register h 309. For this, the sixth multiplexer 317 selects the value (Σ₁(e)) output by the fourth operation function operator 311 from among the input values to output the same to the second adder 314, and the second adder 314 adds the value (h+Ch(e,f,g)+Kⱼ) stored in the register h 309 and the value (Σ₁(e)) output by the sixth multiplexer 317 and outputs the added value. The value added (Σ₁(e)+Ch(e,f,g)+h+Kⱼ) by the second adder 314 is stored in the register h 309 through the fifth multiplexer 316.

In the fourth stage, the second adder 314 adds the value (Σ₁(e)+Ch(e,f,g)+h+Kⱼ) stored in the register h 309 in the previous stage and the intermediate data (Wⱼ) input by the message scheduler 103 to output the added value (Σ₁(e)+Ch(e,f,g)+h+Kⱼ+Wⱼ) which is stored in the register h 309. For this, the sixth multiplexer 317 selects the intermediate data (Wⱼ) input by the message scheduler 103 from among the input values and outputs the same to the second adder 314, and the second adder 314 adds the value (Σ₁(e)+Ch(e,f,g)+h+Kⱼ) stored in the register h 309 and the value (Wⱼ) output by the sixth multiplexer 317, and outputs the added value. The value added (Σ₁(e)+Ch(e,f,g) h+Kⱼ+Wⱼ) by the second adder 314 is stored in the register h 309 through the fifth multiplexer 316.

Here, the second adder 314 has added the intermediate data (Wⱼ) output by the message scheduler 103 in the fourth stage of the message compression operation, that is, in the fourth clock cycle, because it has considered the temporal characteristic in which the message scheduler 103 uses 4 clock cycles so as to calculate the intermediate data (Wⱼ). Since the message compressor 104 needs 7 clock cycles so as to perform the per-round message compression operation, sufficient time for the message scheduler 103 to calculate the intermediate data (Wⱼ) is guaranteed. Therefore, in the exemplary embodiment of the present invention, the message scheduler 103 needs no additional clock signals for calculating the intermediate data (Wⱼ), and can concurrently perform the message schedule operation and the message compression operation.

In the exemplary embodiment of the present invention, when the message compression operation is performed, the intermediate data output by the message scheduler 103 in the fourth stage for each round are added, and it is also possible in the present invention to add the intermediate data output by the message scheduler 103 in the stages after the fourth stage.

In the fifth stage, the second adder 314 adds the value (Σ₁(e)+Ch(e,f,g)+h+Kⱼ+Wⱼ) stored in the register h 309 in the previous stage and the initial value (d) stored in the register d 305 to output the added value (d+Σ₁(e)+Ch(e,f,g)+h+Kⱼ+Wⱼ) which is stored in the register d 305. For this, the sixth multiplexer 317 selects the value (d) input by the register d 305 from among the input values to output the same to the second adder 314, and the second adder 314 adds the value (Σ₁(e)+Ch(e,f,g)+h+Kⱼ+Wⱼ) stored in the register h 309 and the value (d) output by the sixth multiplexer 317 to output the added value. The value added (d+Σ₁(e)+Ch(e,f,g)+Kⱼ+Wⱼ) by the second adder 314 is stored in the register d 305 through the fourth multiplexer 315.

In the fifth stage, the register h 309 does not store the value output by the second adder 314. That is, when the fifth stage is performed, the register h 309 maintains the value (Σ₁(e)+Ch(e,f,g)+h+Kⱼ+Wⱼ) stored in the previous stage, and the output value (d+Σ₁(e)+Ch(e,f,g)+h+Kⱼ+Wⱼ) of the second adder 314 is stored in the register d 305. It is given to perform e=d+T₁ in Equation 3, and the value stored in the register d 305 is shifted to the register e 306 in the last stage of the message compression operation.

In the sixth stage, the second adder 314 adds the value (Σ₁(e)+Ch(e,f,g)+h+Kⱼ+Wⱼ) stored in the register h 309 in the previous stage and the value (Maj(a,b,c)) output by the fifth operation function operator 312 to output the added value (Maj(a,b,c)+Σ₁(e)+Ch(e,f,g)+h+Kⱼ+Wⱼ) which is stored in the register h 309. For this, the sixth multiplexer 317 selects the value (Maj(a,b,c)) output by the fifth operation function operator 312 from among the input values to output it to the second adder 314, and the second adder 314 adds the value (Σ₁(e)+Ch(e,f,g)+h+Kⱼ+Wⱼ) stored in the register h 309 and the value (Maj(a,b,c)) output by the sixth multiplexer 317 to output the added value. The value (Maj(a,b,c)+(Σ₁(e)+Ch(e,f,g)+h+Kⱼ+Wⱼ) added by the second adder 314 is stored in the register h 309 through the fifth multiplexer 316.

In the seventh stage, the second adder 314 adds the value (Maj(a,b,c)+(Σ₁(e)+Ch(e,f,g)+h+Kⱼ+Wⱼ) stored in the register h 309 in the previous stage and the value (Σ₀(a)) output by the sixth operation function operator 313 to output the added value (Σ₀(a)+Maj(a,b,c)+Σ₁(e)+Ch(e,f,g)+h+Kⱼ+Wⱼ) which is stored in the register a 302. For this, the sixth multiplexer 317 selects the value (Σ₀(a)) output by the sixth operation function operator 313 from among the input values to output it to the second adder 314, and the second adder 314 adds the value (Maj(a,b,c)+Σ₁(e)+Ch(e,f,g)+h+Kⱼ+Wⱼ)) stored in the register h 309 and the value (Σ₀(a)) output by the sixth multiplexer 317 to output the added value. The value (Σ₀(a)+Maj(a,b,c)+Σ₁(e)+Ch(e,f,g)+h+Kⱼ+Wⱼ) added by the second adder 314 is stored in the register a 302. Here, the value (Σ₀(a)+Maj(a,b,c)+Σ₁(e)+Ch(e,f,g)+h+Kⱼ+Wⱼ) output by the second adder 314 is stored in the register a 302, and simultaneously the stored values are shifted by one to be stored in the registers. That is, the value stored in the register a 302 is shifted to the register b 303, and the value stored in the register b 303 is shifted to the register c 304. Also, the value stored in the register c 304 is shifted to the register d 305 through the fourth multiplexer 315, and the value (d+Σ₁(e)+Ch(e,f,g)+h+Kⱼ+Wⱼ) stored in the register d 305 in the fifth stage is shifted to the register e 306. Further, the value stored in the register e 306 is shifted to the register f 307, the value stored in the register f 307 is shifted to the register g 308, and the value stored in the register g 308 is shifted to the register h 309 through the fifth multiplexer 316.

The message compression operation in the seventh stage is repeated over the 64 rounds, and when the 64-round message compression operation is completed, the intermediate value caused by the message compression operation is stored in each register.

When the entire message compression operation is finished over the 64 rounds, the message compressor 104 updates initial values as shown in Equation 4 in order to acquire the final result data of the SHA-256 operation, and loads the updated initial values on the respective registers (S203).

H₀=H₀+a, H₁=H₁+b, . . . , H₇=H₇+h (Equation 4)

The initial value update process is performed in a like manner of the process for loading the initial values on the respective registers over the initial 8clock cycles. However, the registers are reset with 0 when loading the initial value, and the intermediate values that are the results of the message compression operations over the 64 rounds are stored in the respective registers when updating the initial value.

In further detail on the initial value update process, the second memory 301 sequentially outputs the initial values stored in the second memory 301 for each clock cycle based on the control signal of the controller 102. That is, the second memory 301 outputs H₇ from among the initial values at the first clock cycle, and sequentially outputs the initial values in the order of H₆, H₅, . . . , H₀ for each subsequent clock cycle. Also, the fourth multiplexer 315 outputs the value output by the second memory 301 from among the input values to the second adder 314, and the second adder 314 adds the value output by the second memory 301 for each clock cycle and the value stored in the register h 309 to output the added value to the register a 302. Here, the value output by the second adder 314 is stored in the register a 302, and simultaneously, the values stored in the registers a to g are shifted by one step to be stored in the registers b to h.

For example, the initial value H₇ output by the second memory 301 and the intermediate value (h) stored in the register h 309 are added at the first clock cycle, and the added value (h+H₇) is stored in the register a 302. Also, the intermediate data stored in the registers a to g are shifted by one stage to be stored in the registers b to h.

Further, in the second clock cycle, the initial value H₆ output by the second memory 301 and the intermediate value (e) stored in the register h in the previous clock cycle are added. Here, since the intermediate value stored in the register e 306 is shifted to the register h 309 in the first clock cycle, the second adder 314 outputs the added value (e+H₆) of the intermediate value stored in the register e 306 and the initial value H₆ to the register a 302 in the second clock cycle. Therefore, the value (e+H₆) output by the second adder 314 is stored in the register a 302, and simultaneously, the values stored in the register a to g in the first clock cycle are shifted by one stage to be stored in the registers b to h. Accordingly, after the second clock cycle, the value (e+H₆) is stored in the register a 302, the value (h+H₇) is stored in the register b 303, and the values stored in the registers a to f in the previous clock cycle are shifted and stored in the other registers c to h.

When the initial value update process during the 8 clock cycles is finished according to the above-noted method, the values stored in the respective registers are given as Equation 5.

a=a+H₀, b=b+H₁, c=c+H₂, . . . , h=h+H₇ (Equation 5)

When the initial value update process is completed, the values stored in the respective registers become the final resultant data having performed the SHA-256 operation, and the controller 102 updates the initial values stored in the second memory 301 with the values stored in the registers. When the SHA-256 operation is performed once, the updated initial values (H₀, H₁, . . . , H₇) stored in the second memory 301 are output as the final resultant data of the SHA-256 operation through a system bus. Further, when the SHA-256 operation is repeatedly performed, the updated initial values are used as initial values for the message compression operation.

Therefore, when the length of the message for performing the SHA-256 operation is greater than the 512 bits and the message schedule operation and the message compression operation must be performed a plurality of times, the message compressor 104 can omit the initial value loading process since initial values (H₀, H₁, . . . , H₇) are loaded to the respective registers from the second message compression operation.

In the above-described message compression operation, a control signal for selecting one of the values input by the fourth multiplexer 315, the fifth multiplexer 316, and the sixth multiplexer 317 and a control signal (write signal) for storing data in the registers are output by the controller 102, and the controller 102 controls the multiplexer and register for each clock cycle so as to perform the message compression operation according to the order of Table 2.

As described above, a single adder is used to realize the message compressor 104 in the exemplary embodiment of the present invention. Therefore, it is possible to reduce the circuit area and power consumption of the message compressor 104 for performing the message compression operation, which is applicable to the low power consumption embedded system such as a mobile phone.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A secure hash algorithm (SHA)-based cryptographic device comprising:
a message scheduler, including an adder, for outputting part of data from among input operation data as per-round intermediate data before a first round, and using the adder to add a resultant value generated by performing a first operation function of the SHA on first intermediate data, and a resultant value generated by performing a second operation function of the SHA on second intermediate data, third intermediate data, and fourth intermediate data according to a predetermined order over a plurality of stages to output an added value as intermediate data for each round from the first round; and
a message compressor for generating final resultant data of a hash operation by performing a message compression operation on the intermediate data output by the message scheduler for each round.

2. The cryptographic device of claim 1, further including
a controller for outputting a control signal for controlling an operation performance order and a result storing process of the message scheduler and the message compressor.

3. The cryptographic device of claim 2, wherein
the message scheduler further includes:
a memory having the same size as the input data, storing the input operation data as per-round intermediate data before the first round based on a control signal of the controller, and storing intermediate data output by the message scheduler for each round from the first round; and
a first multiplexer for selecting the input operation data and outputting the same to the memory before the first round based on the control signal of the controller, and selecting intermediate data output by the message scheduler for each round and outputting the same to the memory from the first round.

4. The cryptographic device of claim 3, wherein
the memory outputs part of the input operation data as per-round intermediate data before the first round based on the control signal of the controller, and outputs one of the first intermediate data, the second intermediate data, the third intermediate data, and the fourth intermediate data for each round from the first round.

5. The cryptographic device of claim 4, wherein
the message scheduler further includes:
a first operation function operator for outputting a resultant value of performing the first operation function on the first intermediate data output by the memory; and
a second operation function operator for outputting a resultant value of performing the second operation function on the second intermediate data output by the memory.

6. The cryptographic device of claim 5, wherein
the message scheduler further includes a second multiplexer for selecting one of an output value of the first operation function operator, an output value of the second operation function operator, and the third intermediate data output by the memory for each stage from the first round based on the control signal of the controller, and outputting the same to the adder.

7. The cryptographic device of claim 6, wherein
the message scheduler further includes:
a third multiplexer for selecting per-round intermediate data output by the memory and outputting the same before the first round based on the control signal of the controller, and selecting one of the fourth intermediate data output by the memory and the output value of the adder for each stage from the first round and outputting the selected one; and
a register for storing an output value of the third multiplexer and outputting the stored value to the memory and the adder.

8. The cryptographic device of claim 1, wherein
the SHA includes the SHA-256.

9. A secure hash algorithm (SHA)-based cryptographic device comprising:
a message scheduler for generating and outputting per-round intermediate data by using input operation data; and
a compressor including an adder and a plurality of registers, and loading a plurality of initial values onto the plurality of registers when a hash operation starts, adding values stored in the registers, resultant values acquired by performing operation functions of a hash operation by using the values stored in the registers, the intermediate data, and the round constant through the adder according to a predetermined order through a plurality of stages for each round of a message compression operation when the initial values are loaded, updating the values stored in the registers by using the value added through the adder, and generating final resultant data by adding the plurality of initial values and the values stored in the registers when the message compression operation performed over the plurality of rounds is finished.

10. The cryptographic device of claim 9, further including
a controller for outputting a control signal for controlling an operation performance order and a result storing process of the message scheduler and the message compressor.

11. The cryptographic device of claim 9, wherein
the message compressor includes:
a first operation function operator for outputting a resultant value acquired by performing a first operation function from among the operation functions by using the values stored in a register e, a register f, and a register g from among the plurality of registers;
a second operation function operator for outputting a resultant value acquired by performing a second operation function from among the operation functions by using the value stored in the register e;
a third operation function operator for outputting a resultant value acquired by performing a third operation function from among the operation functions by using the values stored in a register a, a register b, and a register c from among the plurality of registers; and
a fourth operation function operator for outputting a resultant value acquired by performing a second operation function from among the operation functions by using the value stored in the register a.

12. The cryptographic device of claim 11, wherein
the message compressor further includes
a memory for storing the plurality of initial values and the round constant, sequentially outputting the plurality of initial values while loading the initial values to the registers based on a control signal of the controller, outputting the corresponding round constant for each round of the message compression operation, and sequentially outputting the initial values when the message compression operation performed over the plurality of rounds is finished.

13. The cryptographic device of claim 12, wherein
the message compressor further includes
a multiplexer for selecting an initial value output by the memory and outputting the same while loading the plurality of initial values to the plurality of registers, selecting and outputting one of an output value of the first operation function operator, an output value of the second operation function operator, an output value of the third operation function operator, a value stored in a register d from among the registers, the intermediate data, and the round constant for respective stages for each round of the message compression operation, and selecting and outputting the initial value output by the memory when the message compression operation performed over the plurality of rounds is finished, and
the adder adds the value stored in a register h from among the plurality of registers and the output value of the multiplexer to output it to the register a, the register d, and the register h.

14. The cryptographic device of claim 9, wherein
the plurality of registers include shift registers.

15. A message schedule operation method of a secure hash algorithm (SHA)-based cryptographic device, the method comprising:
when receiving operation data, dividing the operation data into a plurality of blocks to store them into a memory having the same size as the operation data;
before a first round, sequentially outputting a plurality of blocks stored in the memory as per-round intermediate data of the first round; and
from the first round, adding a resultant value acquired by performing a first operation function of the SHA on the first intermediate data output in the previous first round, a resultant value acquired by performing a second operation function of the SHA on the second intermediate data output in the previous second round, and third intermediate data and fourth intermediate data output in the previous third round and fourth round according to a predetermined order through a plurality of stages by using an adder for each round, and outputting per-round intermediate data from the first round.

16. The method of claim 15, wherein
the per-round intermediate data from the first round are sequentially stored in the memory, and the first intermediate data, the second intermediate data, the third intermediate data, and the fourth intermediate data are output by the memory.

17. The method of claim 16, wherein
the outputting of per-round intermediate data from the first round includes:
outputting a first resultant value generated by adding the third intermediate data and a resultant value acquired by performing the first operation function through the adder;
outputting a second resultant value acquired by adding the first resultant value and the fourth intermediate data through the adder; and
outputting a third resultant value acquired by adding a resultant value generated by performing the second operation function to the second resultant value through the adder,
wherein the third resultant value represents intermediate data of the corresponding round.

18. A method for performing a message compression operation including a first operation function, a second operation function, a third operation function, and a fourth operation function by using per-round intermediate data generated through a message schedule operation of a secure hash algorithm (SHA)-based cryptographic device, the method comprising:
loading a plurality of initial values to a plurality of registers including a first register, a second register, and a third register;
adding a value stored in the first register, resultant values acquired by respectively performing the first operation function, the second operation function, the third operation function, and the fourth operation function by using part of the plurality of registers, intermediate data of the corresponding round, and a round constant according to a predetermined order through a plurality of stages by using an adder, and selectively storing the added resultant values in one of the first register, the second register, and the third register;
shifting values stored in the registers other than the third register from among the plurality of registers to neighboring registers by one step and storing them;
repeating the selectively storing and the shifting, and storing over a plurality of rounds; and
adding the values stored in the plurality of registers and the plurality of initial values, and outputting final resultant data of the hash operation.

19. The method of claim 18, wherein
the selectively storing includes:
storing a first resultant value acquired by adding a value stored in the first register, resultant values acquired by performing the first operation function and the second operation function, corresponding intermediate data, and a round constant according to a predetermined order through a plurality of stages by using an adder in the first register;
storing a second resultant value acquired by adding a value stored in the second register and a value stored in the first register by using the adder in the second register;
storing a third resultant value acquired by adding a value stored in the first register and a resultant value acquired by performing the third operation function by using the adder in the first register; and
storing a fourth resultant value acquired by adding a value stored in the first register and a resultant value acquired by performing the fourth operation function by using the adder in the third register.

20. The method of claim 19, wherein
the loading includes
storing one of the plurality of initial values in the third register, shifting values stored in the registers other than the third register by one step to the neighboring registers and storing them, and repeating the storing, shifting, and storing by the number of the plurality of registers.

21. The method of claim 19, wherein
the outputting includes
storing a value acquired by adding one of the plurality of initial values and a value stored in the first register by using the adder in the third register, shifting the values stored in the registers other than the third register from among the plurality of registers to the neighboring registers by one step and storing them, and repeating the storing, shifting, and storing process by the number of the plurality of registers; and
outputting the values stored in the plurality of registers as the final resultant data.

22. The method of claim 21, wherein
the final resultant data stored in the plurality of registers are used as initial values of the message compression operation.
